(19) United States
(12) Patent Application Publication
(10) Pub. No.: US 2011/0242494 A1
(43) Pub. Date: Oct. 6, 2011

(54) MULTI-PROJECTION SYSTEM AND METHOD FOR INSTALLING PROJECTOR IN MULTI-PROJECTION SYSTEM

(75) Inventors: Shun Imai, Matsumoto-shi (JP); Toshiki Fujimori, Shimosuwa-machi (JP)

(73) Assignee: Seiko Epson Corporation, Tokyo (JP)

(21) Appl. No.: 13/078,319

(22) Filed: Apr. 1, 2011

(30) Foreign Application Priority Data
Apr. 2, 2010 (JP) 2010-085827

(51) Int. Cl. G03B 21/26

(52) U.S. Cl. 353/30

(57) ABSTRACT

A multi-projection system includes a first projector projecting a first image, a second projector projecting a second image , and an optical light blocking apparatus blocking part of an image light corresponding to the first image and part of an image light corresponding to the second image to adjust the brightness of a superimposed region. The installation positions of the first projector and the second projector are set in such a way that a tinge which appears in the first image and a tinge which appears in the second image are the same type of color in the superimposed region as a result of part of the image light being blocked by the optical light blocking apparatus.

The entire disclosure of Japanese Patent Application No. 2010-085827, filed Apr. 2, 2010 is expressly incorporated by reference herein.

### BACKGROUND

1. Technical Field

The present invention relates to a multi-projection system and a method for installing a projector in the multi-projection system.

2. Related Art

A multi-projection system has been known which can generate a high-resolution and high-brightness image by forming one entire image by arranging partial images projected from a plurality of projectors on a screen which is a projection surface, the high-resolution and high-brightness image which cannot be realized by one projector. In such a multi-projection system, processing for making a boundary between the partial images less noticeable by projecting the partial images on the screen in such a way that a superimposed region is formed in the adjacent partial images is performed.

FIG. 8 is a diagram showing the configuration of a multi-projection system which displays partial images G1 and G2 on a screen SCR in such a way that a superimposed region A is formed. In the multi-projection system shown in FIG. 8, the superimposed region A is formed between the partial image G1 projected from a projector PJ1 and the partial image G2 projected from a projector PJ2.

FIG. 9 is a diagram showing the brightness of the partial images G1 and G2 on the screen SCR, the partial images G1 and G2 shown in FIG. 8. As shown in FIG. 9, since the superimposed region A (shown as a gray zone) becomes brighter than the other regions, the presence of the superimposed region A is visually recognized easily. To solve this problem, a technique called edge blending is adopted to equate the brightness of the superimposed region A and the brightness of the other regions.

As a representative technique of edge blending, there is a technique of adjusting the brightness of a superimposed region by using a light shielding plate serving as an optical light blocking apparatus (for example, see JP-A-5-103286 (hereinafter referred to as Patent Document 1)).

A technique described in Patent Document 1 (hereinafter referred to as an existing technique) is a technique of adjusting the brightness of a superimposed region by placing a light shielding plate on an optical path of a projected image projected from a projector.

FIG. 10 is a diagram showing the brightness of the partial images G1 and G2 on the screen SCR when a brightness adjustment of the superimposed region has been performed by using the light shielding plate. As shown in FIG. 10, when light shielding plates S1 and S2 are placed in appropriate positions with respect to the optical paths of the projectors PJ1 and PJ2, it is possible to make the brightness of the partial images on the screen SCR uniform as a whole.

However, when the brightness adjustment of the superimposed region is performed by using the light shielding plates S1 and S2, an unnecessary tinge (hereinafter simply referred to as a tinge) sometimes appears in the superimposed region A. In particular, the tinge often appears as a blue tinge or a red tinge because of the wavelength.

FIG. 11 is a diagram explaining a tinge which appears in a superimposed region A when the brightness adjustment of the superimposed region has been performed by using a light shielding plate. FIG. 11 deals with a case in which one projector (which is assumed to be a projector PJ1) is used.

As shown in FIG. 11, when light shielding plates (which are assumed to be light shielding plates S0 and S1) are placed in such a way that predetermined light blocked regions L and R are set on the sides of a partial image G1 projected from the projector PJ1, a blue tinge appears in the light blocked region L on the left side of the partial image G1 and a red tinge appears in the light blocked region R on the right side of the partial image G1, for example.

Incidentally, in FIG. 11, a case in which a blue tinge appears in the light blocked region L on the left side of the partial image G1 and a red tinge appears in the light blocked region R on the right side of the partial image G1 is shown as an example. When projectors are installed in the same installation positions, depending on the model of the projectors, the blue tinge appears on one side of the partial image G1 and the red tinge appears on the other side thereof in one projector, and the blue tinge and the red tinge appear on the same respective sides in the other projector. Thus, when the projectors PJ1 and PJ2 are of the same model and are used in the same installation positions, the blue tinge appears on one side of a partial image and the red tinge appears on the other side thereof in the projector PJ1, and the blue tinge and the red tinge appear on the same respective sides in the projector PJ2.

FIGS. 12A and 12B are diagrams showing an example of a change in the brightness in a position of the partial image G1 in a horizontal direction. FIG. 12A is a diagram explaining a change in the brightness in the light blocked region L on the left side of the partial image G1 shown in FIG. 11, and FIG. 12B is a diagram explaining a change in the brightness in the light blocked region R on the right side of the partial image G1 shown in FIG. 11. When the partial image G1 is projected on the screen SCR, as a result of the light being blocked by the light shielding plates S1 and S2, white balance changes in the light blocked regions L and R of the partial image G1, and, as shown in FIGS. 12A and 12B, a change in brightness in a position in the light blocked regions L and R in the horizontal direction differs from color component to color component of red (R), green (G), and blue (B).

Such a phenomenon is considered to be caused by various factors such as adjustment errors of optical parts such as a dichroic mirror, a cross dichroic prism, and a liquid crystal panel and the incident angle dependence of the transmittance of an optical modulator.

FIG. 13 is a diagram explaining a tinge which appears in a light blocked region R of a partial image G1 and a tinge which appears in a light blocked region L of a partial image G2. Incidentally, FIG. 13 shows a state in which the partial images G1 and G2 are not superimposed.

As shown in FIG. 13, when the light shielding plates S1 and S2 are placed in part of the optical paths of the projectors PJ1 and PJ2 and white images serving as the partial images G1 and G2 are projected from the projectors PJ1 and PJ2, different tinges sometimes appear in the light blocked region R of the projector PJ1 and the light blocked region L of the projector PJ2. In FIG. 13, a case in which a red tinge appears in the light blocked region R of the partial image G1 and a blue tinge appears in the light blocked region L of the partial image G2 is shown as an example.

FIG. 14 is a diagram showing a state in which a superimposed region A is formed by superimposing the light blocked regions R and L of the partial images G1 and G2 which are shown in FIG. 13. In this case, even if the amount of light is adjusted by the light shielding plates S1 and S2 in such a way that the brightness of the superimposed region A in the partial images G1 and G2 of the projectors PJ1 and PJ2 becomes the same as the brightness of the other regions, color unevenness shows up due to tinges (a red tinge and a blue tinge) which appear as a result of the projectors PJ1 and PJ2. In this case, both the blue tinge and the red tinge are present in the superimposed region A.

That is, in FIGS. 13 and 14, it is assumed that the projectors PJ1 and PJ2 are of the same model and are used in the same installation positions. In this case, since one tinge appears on one sides of the partial images G1 and G2 and the other tinge appears on the other sides of the partial images G1 and G2, when the light blocked region R on the right side of the partial image G1 and the light blocked region L on the left side of the partial image G2 are superimposed, both the red tinge and the blue tinge appear in the superimposed region A.

As described above, when color unevenness shows up in the superimposed region A and different colors are present therein, processing for correcting the color unevenness becomes complicated as compared to a case in which color unevenness by a single color is corrected.

### SUMMARY

An advantage of some aspects of the invention is to provide a multi-projection system and a method for installing a projector in the multi-projection system, the system and the method which can easily perform a color correction to suppress a tinge which appears in a superimposed region when a brightness adjustment of the superimposed region is performed by using an optical light blocking apparatus.

A multi-projection system according to an aspect of the invention includes: a first projector projecting a first image on a projection surface; a second projector projecting a second image on the projection surface in such a way that the second image is adjacent to the first image and a superimposed region is formed as a result of part of the second image being superimposed on the first image; and an optical light blocking apparatus blocking part of an image light corresponding to the first image and part of an image light corresponding to the second image to adjust the brightness of the superimposed region, and the first projector and the second projector are installed in such a way that a tinge which appears in the first image and a tinge which appears in the second image are the same type of color in the superimposed region as a result of part of the image light being blocked by the optical light blocking apparatus.

With the multi-projection system according to the aspect of the invention, it is possible to make the tinges which appear in the superimposed region have the same type of color in the superimposed region. This makes it possible to perform easily a color correction for suppressing a tinge which appears in the superimposed region.

Moreover, with the multi-projection system according to the aspect of the invention, by installing the first projector and the second projector which project partial images adjacent to each other in a horizontal direction in predetermined installation positions, it is possible to make the tinges which appear in the superimposed region have the same type of color in the superimposed region. That is, when the first projector and the second projector are installed in the same installation positions and project the partial images, if the first projector becomes a generation source of a tinge in the superimposed region, the second projector becomes a generation source of the other tinge. However, by installing the first projector in an installation position in which the bottom face of the projector faces in a direction of gravitational force and installing the second projector in an installation position in which the bottom face of the projector faces in a direction of antigravitational force, it is possible to make the tinges which appear in the superimposed region formed in the adjacent partial images have the same type of color.

Furthermore, in the multi-projection system according to the aspect of the invention, a first tinge and a second tinge which is different from the first tinge may appear in the first image and the second image.

As described above, two different tinges appear in the first image and the second image.

In addition, with the multi-projection system according to the aspect of the invention, since the tinges which appear in the superimposed region become tinges of the same type of color, it is possible to perform easily a color correction for suppressing a tinge.

Moreover, in the multi-projection system according to the aspect of the invention, since the tinges which appear in the superimposed region are tinges of the same type of color, when the tinge which appears in the superimposed region is a red tinge, for example, the optical light blocking apparatus having a filtering function of preventing a red color from passing therethrough may be used.

In the multi-projection system according to the aspect of the invention, the first tinge maybe a reddish color and the second tinge may be a bluish color.

As described above, the tinges which appear in the superimposed region become a bluish color and a reddish color because of the difference in wavelength of color, and, of red, green, and blue, red and blue tend to appear as a tinge in the superimposed region.

Another aspect of the invention is directed to a method for installing a projector in a multi-projection system including a first projector projecting a first image on a projection surface, a second projector projecting a second image on the projection surface in such a way that the second image is adjacent to the first image and a superimposed region is formed as a result of part of the second image being superimposed on the first image, and an optical light blocking apparatus blocking part of an image light corresponding to the first image and part of an image light corresponding to the second image to adjust the brightness of the superimposed region, wherein the first projector and the second projector are installed in such a way that a tinge which appears in the first image and a tinge which appears in the second image are the same type of color in the superimposed region as a result of the image light being blocked by the optical light blocking apparatus.

With the method for installing a projector in a multi-projection system according to this aspect of the invention, it is possible to make the tinges which appear in the superimposed region have the same type of color in the superimposed region. As described above, by making the tinges which appear in the superimposed region have the same type of color in the superimposed region, it is possible to perform easily a color correction for suppressing a tinge which appears in the superimposed region. Incidentally, it is preferable that the method for installing a projector in a multi-projection system, the method according to this aspect of the invention, also have the features of the multi-projection system according to the aspect of the invention.

### BRIEF DESCRIPTION OF THE DRAWINGS

The invention will be described with reference to the accompanying drawings, wherein like numbers reference like elements.

FIG. 1 is a diagram showing the configuration of a multi-projection system 10 according to a first embodiment.

FIG. 2 is a diagram showing the configuration of an image processing apparatus 200.

FIG. 3 is a diagram showing an outline of the structure of a first projector PJ1 and a second projector PJ2.

FIG. 4 is a diagram explaining tinges which appear in the first projector PJ1 and the second projector PJ2.

FIG. 5 is a diagram showing a state in which a superimposed region A is formed by superimposing the light blocked region R of the partial image G1 and the light blocked region L of the partial image G2 which are shown in FIG. 4.

FIG. 6 is a diagram explaining the configuration of a multi-projection system 20 according to a second embodiment.

FIG. 7 is a diagram showing a state in which the partial images G1 to G3 shown in FIG. 6 are displayed on a screen SCR in such away that superimposed regions A and B are formed.

FIG. 8 is a diagram showing the configuration of a multi-projection system which displays partial images G1 and G2 on the screen SCR in such a way that a superimposed region A is formed.

FIG. 9 is a diagram showing the brightness of the partial images G1 and G2 on the screen SCR, the partial images G1 and G2 shown in FIG. 8.

FIG. 10 is a diagram showing the brightness of the partial images G1 and G2 on the screen SCR when a brightness adjustment of the superimposed region has been performed by using a light shielding plate.

FIG. 11 is a diagram explaining a tinge which appears in the superimposed region A when a brightness adjustment of the superimposed region has been performed by using a light shielding plate.

FIGS. 12A and 12B are diagrams showing an example of a change in the brightness in a position of the partial image G1 in a horizontal direction.

FIG. 13 is a diagram explaining a tinge which appears in the light blocked region R of the partial image G1 and a tinge which appears in the light blocked region L of the partial image G2.

FIG. 14 is a diagram showing a state in which a superimposed region A is formed by superimposing the light blocked regions R and L of the partial images G1 and G2 which are shown in FIG. 13.

### DESCRIPTION OF EXEMPLARY EMBODIMENTS

Hereinafter, an embodiment of the invention will be described.

### First Embodiment

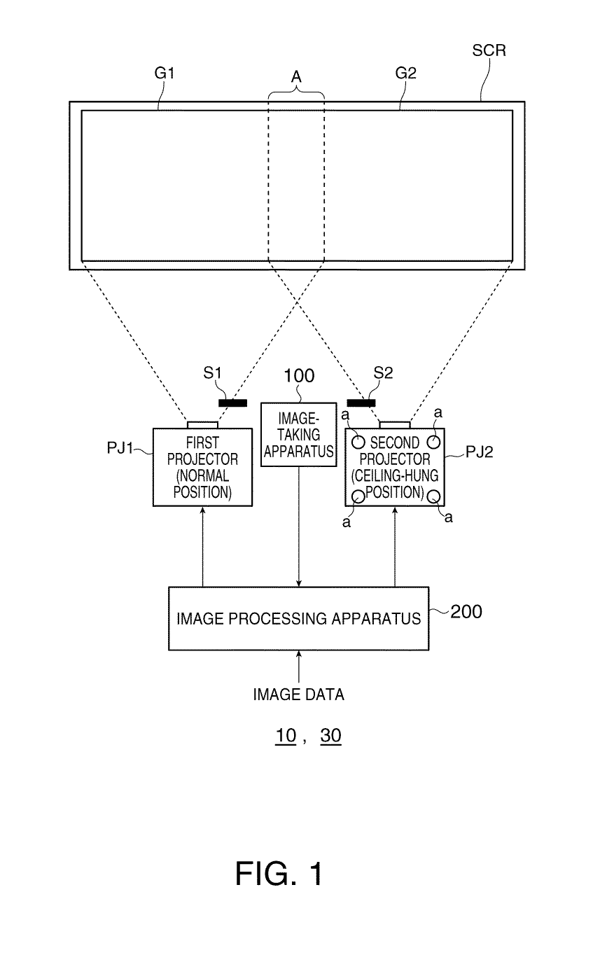

FIG. 1 is a diagram showing the configuration of a multi-projection system 10 according to a first embodiment. As shown in FIG. 1, the multi-projection system 10 according to the first embodiment includes a first projector PJ1, a second projector PJ2, light shielding plates S1 and S2 serving as an optical light blocking apparatus, an image-taking apparatus 100, and an image processing apparatus 200.

The first projector PJ1 projects a partial image G1 (a first image) on a screen SCR. The second projector PJ2 projects a partial image G2 (a second image) on the screen SCR. The second projector PJ2 projects the partial image G2 on the screen SCR in such a way that the partial image G2 is adjacent to the partial image G1 and part of the partial image G2 is superimposed on the partial image G1 to form a superimposed region A. The partial images G1 and G2 are displayed on the screen SCR such that the partial images G1 and G2 are arranged side by side in a horizontal direction, and the superimposed region A is formed so as to make a seam joint between the partial images G1 and G2 less noticeable.

Incidentally, the first projector PJ1 and the second projector PJ2 are assumed to be the projectors of the same model. Moreover, the first projector and the second projector are installed in different installation positions. That is, when the projector PJ1 is installed in a first installation position, the second projector PJ2 is installed in a second installation position which is different from the first installation position.

Here, the first installation position is a normal installation position in which a projector is placed directly on a table or the like. The normal installation position here is an installation position in which the bottom face of a projector (the face on which leg portions a are present) faces in a direction of gravitational force. “The direction of gravitational force” is not limited to a direction which is completely parallel to the direction of gravitational force, but includes a direction which is slightly inclined with respect to the direction of gravitational force. Incidentally, the direction of gravitational force is assumed to be a direction from a front surface to a back surface of a plane of paper when only the first projector PJ1 and the second projector PJ2 are viewed in FIG. 1. Moreover, the second installation position is a position obtained by turning the first installation position upside down vertically along the direction of gravitational force, that is, an installation position in which the bottom face of a projector (the face on which leg portions a are present) faces in a direction of antigravitational force. “The direction of antigravitational force” is not limited to a direction which is completely parallel to the antigravitational force, but includes a direction which is slightly inclined with respect to the direction of antigravitational force. Specifically, the second installation position is an installation position which is used when the projector is used by being hung from a ceiling etc.

Hereinafter, the first installation position is referred to as a “normal position”, and the second installation position is referred to as a “ceiling-hung position”. However, the ceiling-hung position does not mean only a case in which the projector is used by being hung from a ceiling, but includes a case in which the projector is used by being placed on a table or the like. When the projector is placed on the table, the projector is assumed to be placed on the table in such a way that the bottom face of the projector faces in the direction of antigravitational force.

Incidentally, in the multi-projection system 10 according to the first embodiment, it is assumed that the first projector PJ1 is used in a normal position and the second projector PJ2 is used in a ceiling-hung position.

The light shielding plate S1 blocks part of the image light corresponding to the partial image G1 to adjust the brightness of the superimposed region A. Moreover, the light shielding plate S2 blocks part of the image light corresponding to the partial image G2 to adjust the brightness of the superimposed region A.

The image-taking apparatus 100 takes an image of the images (the partial images G1 and G2) displayed on the screen SCR, generates taken image data, and outputs the taken image data to the image processing apparatus 200.

The image processing apparatus 200 has the function of generating a correction parameter based on the taken image data, the function of generating the partial image data corresponding to the partial image G1 projected by the first projector PJ1 and the partial image data corresponding to the partial image G2 projected by the second projector PJ2, the function of performing an image correction based on the correction parameter, and the function of transmitting the partial image data to a corresponding projector.

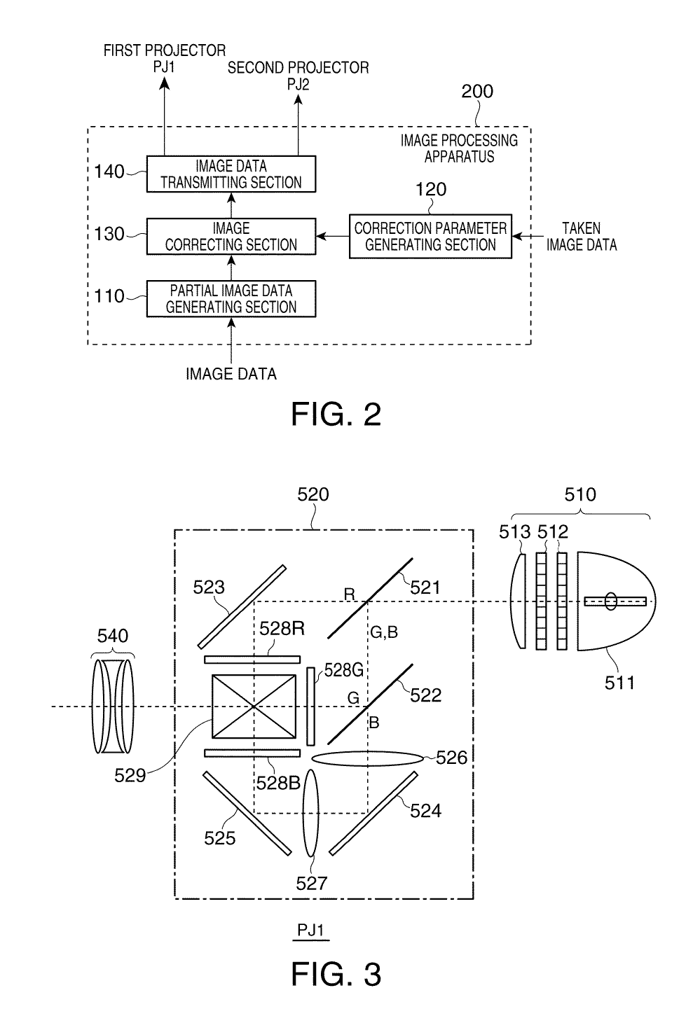

FIG. 2 is a diagram showing the configuration of the image processing apparatus 200. As shown in FIG. 2, the image processing apparatus 200 has a partial image data generating section 110, a correction parameter generating section 120, an image correcting section 130, and an image data transmitting section 140.

The partial image data generating section 110 has the function of generating, from the image data corresponding to the entire image which is displayed on the screen SCR, partial image data corresponding to the partial image G1 to be projected by the first projector PJ1 and partial image data corresponding to the partial image G2 to be projected by the second projector PJ2.

The correction parameter generating section 120 has the function of generating various correction parameters, such as a color correction parameter, based on the taken image data output from the image-taking apparatus 100. The image correcting section 130 has the function of performing various image corrections, such as a color correction, based on the correction parameter generated by the correction parameter generating section 120.

The image data transmitting section 140 has the function of transmitting, to corresponding projectors (the first projector PJ1 and the second projector PJ2), the pieces of partial image data subjected to the image correction by the image correcting section 130.

FIG. 3 is a diagram showing an outline of the structure of the first projector PJ1 and the second projector PJ2. Since the projectors PJ1 and PJ2 have the same structure, the structure of the first projector PJ1 will be described in FIG. 3.

The first projector PJ1 is a so-called three plate-type liquid crystal projector in which optical modulators (which are assumed to be liquid crystal panels) are provided, one for each of the color components of R (red), G (green), and B (blue). As shown in FIG. 3, the first projector PJ1 has a light source device 510, an image forming unit 520, and a projection system 540.

The light source device 510 has a light source 511, a pair of lens arrays 512, and a superimposing lens 513. The image forming unit 520 has dichroic mirrors 521 and 522, reflection mirrors 523, 524, and 525, relay lenses 526 and 527, liquid crystal panels 528R, 528G, and 528B, and a cross dichroic prism 529.

The dichroic mirror 521 separates the light from the light source device 510 into a red light (R) and a green light (G) and a blue light (B). The red light obtained by the separation performed by the dichroic mirror 521 is reflected from the reflection mirror 523 and guided to the liquid crystal panel 528R.

Moreover, the green light and the blue light obtained by the separation performed by the dichroic mirror 521 are separated into a green light and a blue light by the dichroic mirror 522. The green light obtained by the separation performed by the dichroic mirror 522 is made to enter the liquid crystal panel 528G. Furthermore, the blue light obtained by the separation performed by the dichroic mirror 522 is reflected from the reflection mirror 524 via the relay lens 526, and is then reflected from the reflection mirror 525 via the relay lens 527 and guided to the liquid crystal panel 528B.

The liquid crystal panel 528R modulates the red light based on the partial image data. The liquid crystal panel 528G modulates the green light based on the partial image data. The liquid crystal panel 528B modulates the blue light based on the partial image data. The color lights obtained by the modulation performed by the liquid crystal panels 528R, 528G, and 528B are combined by the cross dichroic prism 529.

The projection system 540 enlarges the image light formed of the combined light obtained by the cross dichroic prism 529 and forms an image on the screen SCR (see FIG. 1).

Although the first projector PJ1 has been described in FIG. 3, the second projector PJ2 is assumed to have the same structure as that of the first projector PJ1.

In the multi-projection system 10 according to the first embodiment, the first projector PJ1 and the second projector PJ2 which are shown in FIG. 3 are installed in different installation positions. That is, the first projector PJ1 is installed in a normal position, and the second projector PJ2 is installed in a ceiling-hung position. As a result, it is possible to make the tinges which appear in the superimposed region A have the same type of color.

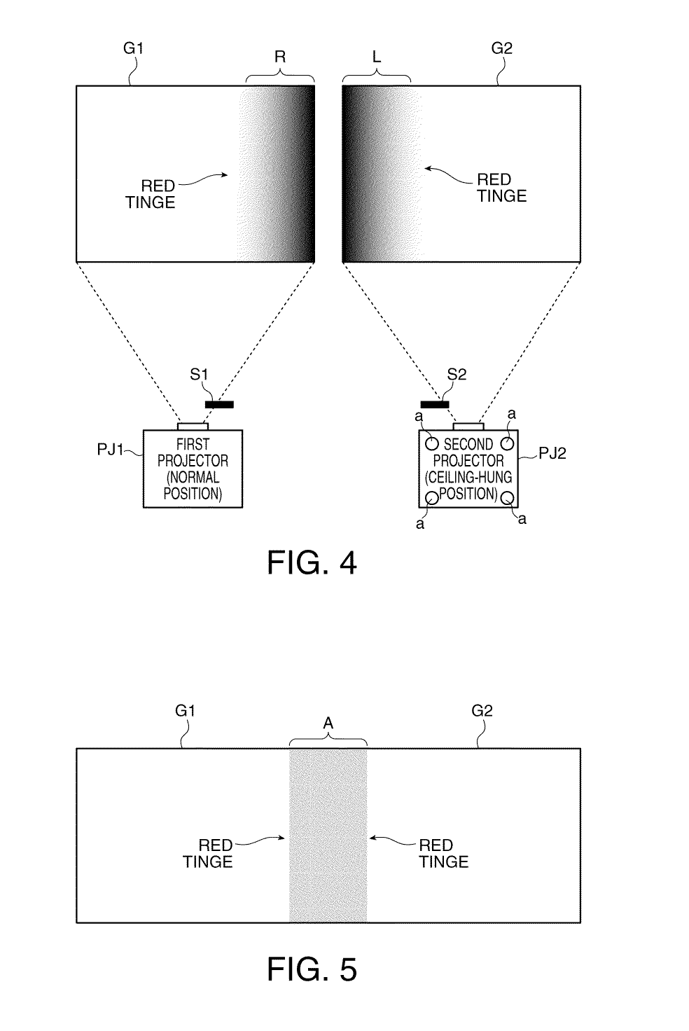

FIG. 4 is a diagram explaining tinges which appear in the first projector PJ1 and the second projector PJ2. Incidentally, as is the case with FIG. 13, FIG. 4 shows a state in which the partial images G1 and G2 are not superimposed.

As shown in FIG. 4, in this case, the same tinge (a first tinge) appears in a light blocked region R on the right side of the partial image G1 and a light blocked region L on the left side of the partial image G2. Incidentally, the first tinge is a reddish color (a red tinge) because, in the multi-projection system 10 according to the first embodiment, the first projector PJ1 is installed in a normal position and the second projector PJ2 is installed in a ceiling-hung position.

FIG. 5 is a diagram showing a state in which a superimposed region A is formed by superimposing the light blocked region R of the partial image G1 and the light blocked region L of the partial image G2 which are shown in FIG. 4. As shown in FIG. 5, in the superimposed region A formed between the partial image G1 and the partial image G2, a red tinge which appears in the light blocked region R of the partial image G1 and a red tinge which appears in the light blocked region L of the partial image G2, the light blocked region R of the partial image G1 and the light blocked region L of the partial image G2 which are shown in FIG. 4, are superimposed. Incidentally, in FIG. 5, although a boundary between the superimposed region A and the other regions is shown as a clear line, the image actually becomes an image in which a faint red tinge appears in the entire superimposed region A.

As shown in FIG. 5, since the tinges which appear in the superimposed region A become the tinges of the same type of color (in this case, red tinges), it is possible to perform color correction processing in the superimposed region A easily . The color correction processing here can be performed, for example, based on the taken image data obtained by the image-taking apparatus 100 by the same processing as the color correction which is normally performed in the individual projectors (the first projector PJ1 and the second projector PJ2).

### Second Embodiment

In the multi-projection system 10 according to the first embodiment, a case in which two projectors are used is shown as an example; however, three or more projectors may be used. In a multi-projection system 20 according to a second embodiment, a case in which three projectors are used will be described.

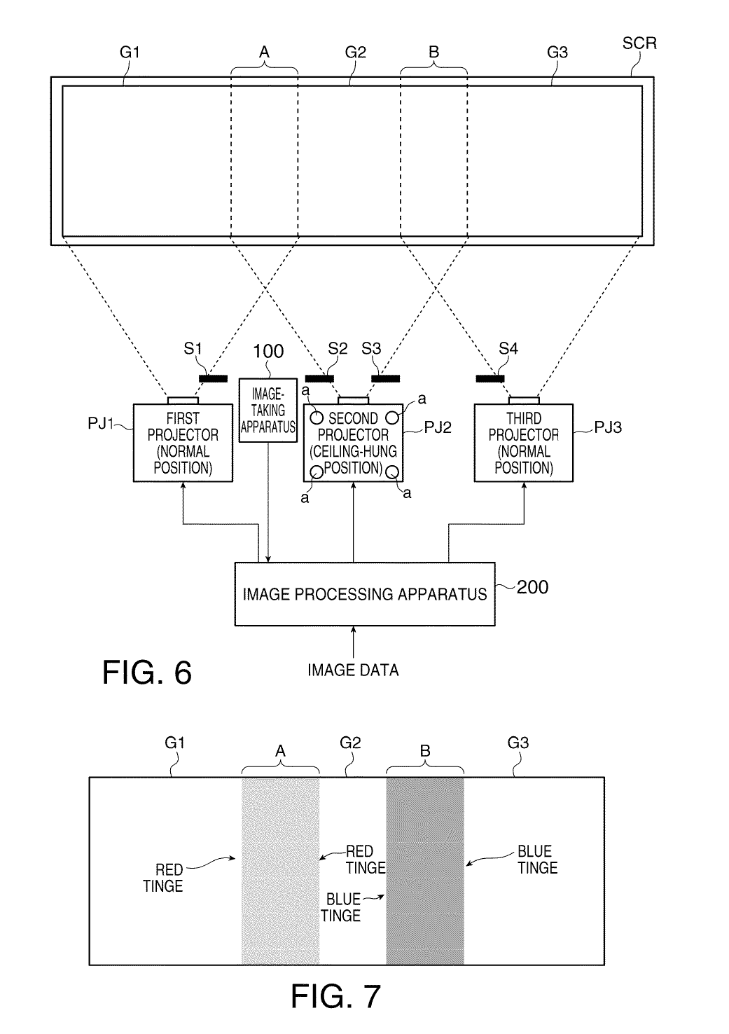

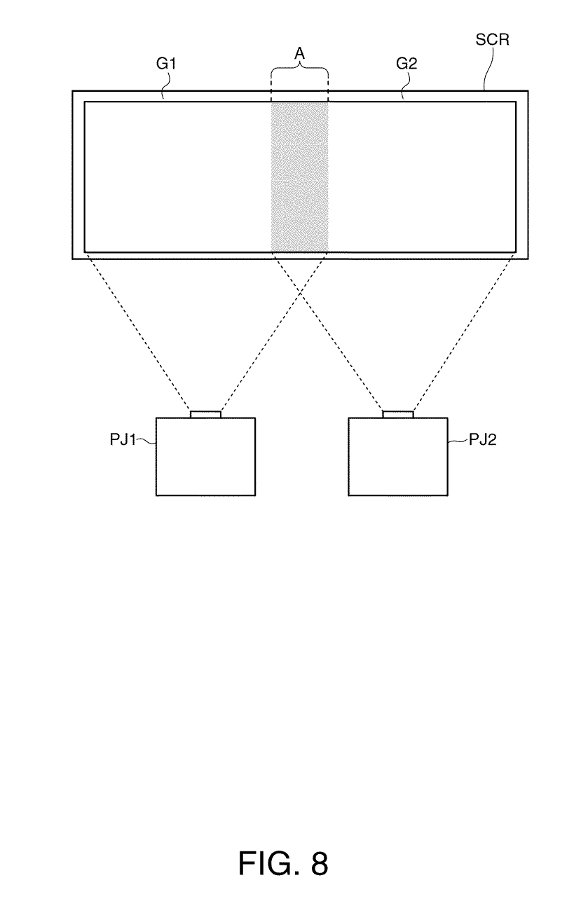

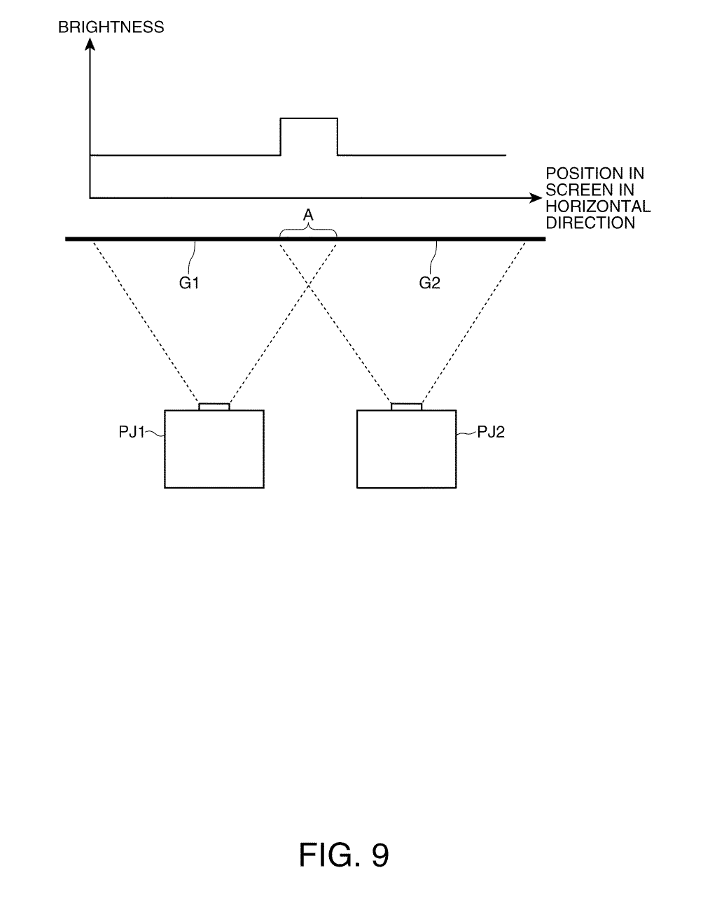

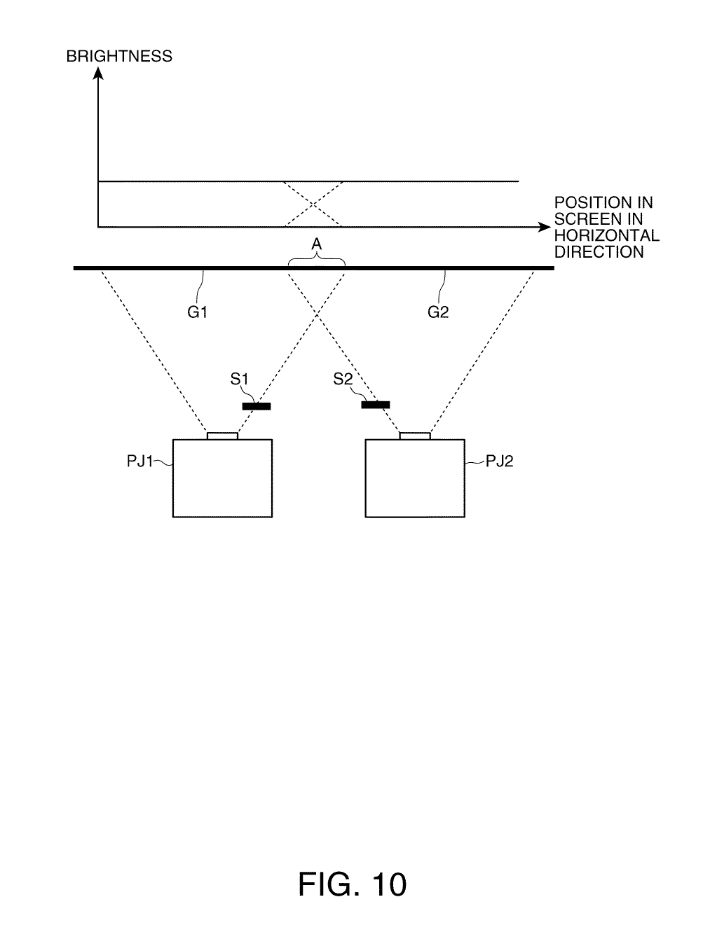

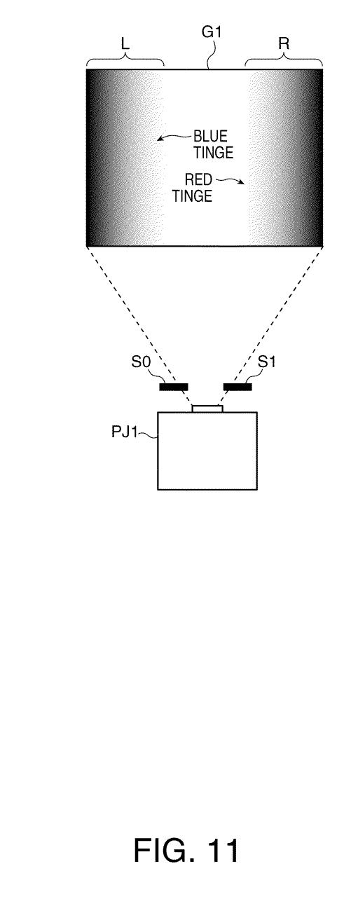

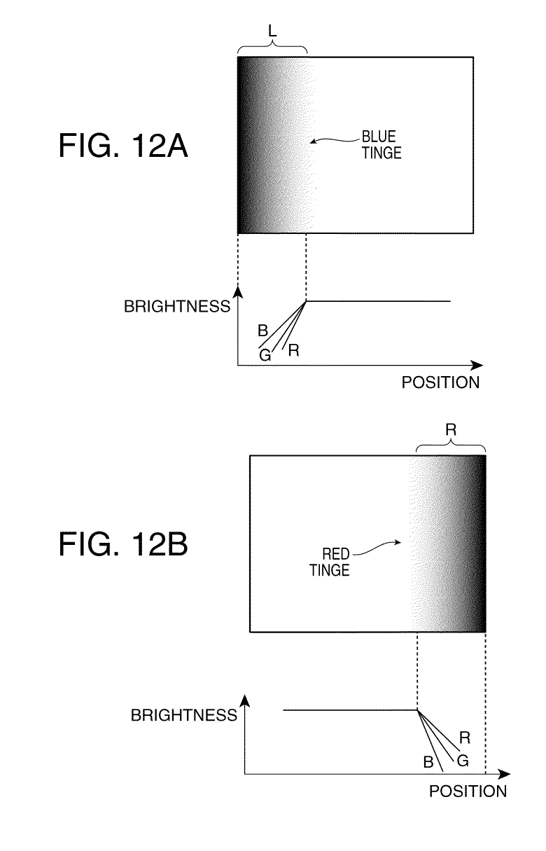

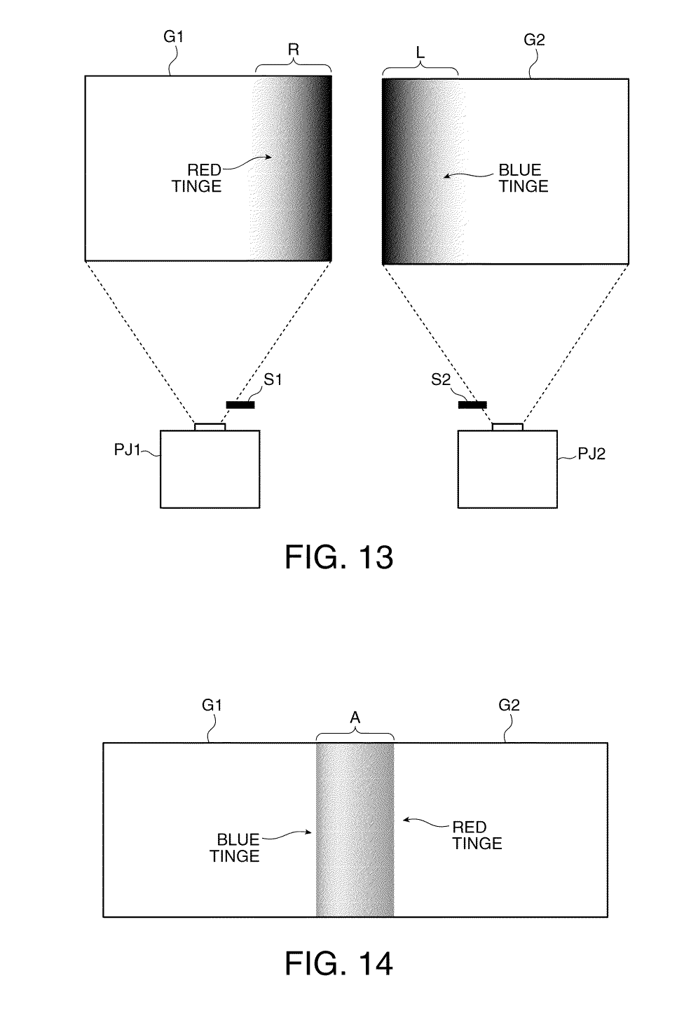

FIG. 6 is a diagram explaining the configuration of the multi-projection system 20 according to the second embodiment. The multi-projection system shown in FIG. 6 differs from the multi-projection system shown in FIG. 1 in that it has three projectors. In other respects, the multi-projection system shown in FIG. 6 is the same as the multi-projection system shown in FIG. 1, and therefore such components as are found also in FIG. 1 will be identified with the same reference numerals.

Incidentally, the multi-projection system 20 according to the second embodiment has three projectors (a first projector PJ1, a second projector PJ2, and a third projector PJ3). It is to be noted that hereinafter the first projector PJ1, the second projector PJ2, and the third projector PJ3 may be referred to as the first to third projectors PJ1 to PJ3.

The installation positions of the first to third projectors PJ1 to PJ3 are as follows. When the first projector PJ1 is installed in a normal position, the second projector PJ2 is assumed to be installed in a ceiling-hung position and the third projector PJ3 is assumed to be installed in a normal position. As described above, the first to third projectors PJ1 to PJ3 are installed in such a way that the projectors are installed in a normal position and a ceiling-hung position alternately. Moreover, in the second projector PJ2, a light shielding plate S3 to block the light in a predetermined region (a region corresponding to a superimposed region B) on a right-edge side of a partial image G2 is provided, and, in the third projector PJ3, a light shielding plate S4 to block the light in a predetermined region (a region corresponding to the superimposed region B) on the left-edge side of a partial image G3 is provided.

When the first to third projectors PJ1 to PJ3 are installed as shown in FIG. 6 and the light shielding plates S1 to S4 are installed as shown in FIG. 6, a red tinge appears in a light blocked region R (not shown) on the right side of the partial image G1 projected from the first projector PJ1, and, similarly, a red tinge appears in a light blocked region L (not shown) on the left side of the partial image G2 projected from the second projector PJ2. Moreover, a bluish color (a blue tinge) serving as a second tinge appears in a light blocked region R (not shown) on the right side of the partial image G2 projected from the second projector PJ2, and, similarly, a blue tinge appears in a light blocked region L (not shown) on the left side of the partial image G3 from the third projector PJ3.

As a result, when the first projector PJ1 and the second projector PJ2 of the first to third projectors PJ1 to PJ3 are regarded as a pair of projectors, as is the case with FIG. 5, a red tinge appears in a superimposed region A in which the light blocked region R of the partial image G1 and the light blocked region L of the partial image G2 are superimposed. Furthermore, when the second projector PJ2 and the third projector PJ3 of the first to third projectors PJ1 to PJ3 are regarded as a pair of projectors, a blue tinge appears in a superimposed region B in which the light blocked region R of the partial image G2 and the light blocked region L of the partial image G3 are superimposed.

FIG. 7 is a diagram showing a state in which the partial images G1 to G3 shown in FIG. 6 are displayed on the screen SCR in such a way that the superimposed regions A and B are formed. As shown in FIG. 7, a red tinge appears in the superimposed region A formed between the partial image G1 and the partial image G2, and a blue tinge appears in the superimposed region B formed between the partial image G2 and the partial image G3.

As described above, the tinge which appears in the superimposed region A and the tinge which appears in the superimposed region B are each a single tinge in each of the superimposed region A and the superimposed region B. As a result of the tinge which appears in the superimposed region A and the tinge which appears in the superimposed region Beach being a single tinge in each superimposed region, as is the case with the multi-projection system 10 according to the first embodiment, it is possible to facilitate a color correction for suppressing the tinges which appear in the superimposed region A and the superimposed region B.

### Third Embodiment

In the multi-projection system 10 according to the first embodiment and the multi-projection system. 20 according to the second embodiment, a case in which a color correction for suppressing a tinge which appears in a superimposed region is performed by image processing is shown as an example. In a multi-projection system 30 according to a third embodiment, the color correction is performed by means of an optical filter.

Incidentally, as is the case with the multi-projection system 10 according to the first embodiment, in the multi-projection system 30 according to the third embodiment, descriptions will be given by taking up, as an example, a case in which two projectors are used. Therefore, since the entire configuration of the multi-projection system 30 as a multi-projection system is the same as that of FIG. 1, the configuration of the multi-projection system 30 according to the third embodiment is not shown.

In the multi-projection system 30 according to the third embodiment, light shielding plates S1 and S2 have the function of an optical filter. That is, in this case, the light shielding plates S1 and S2 are assumed to be optical filters having the characteristics that prevent a red color from passing therethrough. This makes it possible to prevent a red tinge from appearing in a superimposed region A.

Incidentally, this embodiment can also be implemented in the same manner even when three or more projectors are present. For example, as in the multi-projection system 20 according to the second embodiment, when the multi-projection system has first to third projectors PJ1 to PJ3, the light shielding plate S1 and the light shielding plate S2 are assumed to be optical filters having the characteristics that prevent a red color from passing therethrough, and the light shielding plate S3 and the light shielding plate S4 are assumed to be optical filters that prevent a blue color from passing therethrough. This makes it possible to prevent a red tinge from appearing in the superimposed region A and prevent a blue tinge from appearing in the superimposed region B.

As described above, a tinge which appears in each superimposed region is made to become a single tinge, whereby an optical filter which prevents a particular color from passing therethrough can prevent a particular tinge from appearing.

The invention is not limited to the embodiments described above, and various modifications can be made therein without departing from the spirit of the invention. For example, the following modifications (1) and (2) are also possible.

(1) In the embodiments described above, cases in which a plurality of partial images are arranged on a screen only in a horizontal direction have been described as an example. However, the invention is not limited thereto. Also in a case in which m (m is an integer equal to or more than 2) partial images and n (n is an integer equal to or more than 2) partial images are arranged in a horizontal direction and in a vertical direction, respectively, in a matrix, the invention can be practiced in the same manner as in the embodiments described above in the partial images adjacent to each other in a horizontal direction. For example, when a multi-projection system in which display is performed by arranging two partial images in a horizontal direction and two partial images in a vertical direction is configured, projectors PJ1 and PJ2 which are installed in the installation positions shown in FIG. 1 simply have to be installed in two stages vertically (in a vertical direction). Moreover, when a multi-projection system in which display is performed by arranging three partial images in a horizontal direction and two partial images in a vertical direction is configured, first to third projectors PJ1 to PJ3 which are installed in the installation positions shown in FIG. 6 simply have to be installed in two stages vertically (in a vertical direction).

(2) In the embodiments described above, cases in which one image processing apparatus 200 performs generation of divided images or the like for a plurality of projectors have been described as an example. However, image processing apparatuses may be provided, one for each of a plurality of projectors.

What is claimed is:

1. A multi-projection system comprising:
a first projector projecting a first image on a projection surface;
a second projector projecting a second image on the projection surface in such a way that the second image is adjacent to the first image and a superimposed region is formed as a result of part of the second image being superimposed on the first image; and
an optical light blocking apparatus blocking part of an image light corresponding to the first image and part of an image light corresponding to the second image to adjust the brightness of the superimposed region,
wherein
the first projector and the second projector are installed in such away that a tinge which appears in the first image and a tinge which appears in the second image are the same type of color in the superimposed region as a result of part of the image light being blocked by the optical light blocking apparatus.

2. The multi-projection system according to claim 1, comprising:
a plurality of projectors including the first projector and the second projector and projecting a plurality of partial images forming an entire image,
wherein
the first projector and the second projector project partial images of the plurality of partial images, the partial images which are adjacent to each other on the projection surface in a horizontal direction.

3. The multi-projection system according to claim 2, wherein
the first projector is installed in such a way that a bottom face thereof faces in a direction of gravitational force, and
the second projector is installed in such a way that a bottom face thereof faces in a direction of antigravitational force.

4. The multi-projection system according to claim 1, wherein
a first tinge and a second tinge which is different from the first tinge appear in the first image and the second image.

5. The multi-projection system according to claim 4, further comprising:
an image correcting section performing color correction processing to suppress the first tinge and the second tinge.

6. The multi-projection system according to claim 4, wherein
the optical light blocking apparatus has the function of preventing the first tinge or the second tinge from passing therethrough.

7. The multi-projection system according to claim 4, wherein
the first tinge is a reddish color and the second tinge is a bluish color.

8. A method for installing a projector in a multi-projection system including a first projector projecting a first image on a projection surface, a second projector projecting a second image on the projection surface in such a way that the second image is adjacent to the first image and a superimposed region is formed as a result of part of the second image being superimposed on the first image, and an optical light blocking apparatus blocking part of an image light corresponding to the first image and part of an image light corresponding to the second image to adjust the brightness of the superimposed region,
the method comprising:
installing the first projector and the second projector in such a way that a tinge which appears in the first image and a tinge which appears in the second image are the same type of color in the superimposed region as a result of the part of the image light being blocked by the optical light blocking apparatus.
